(19) United States
(12) Patent Application Publication
(10) Pub. No.: US 2012/0187644 A1
(43) Pub. Date: Jul. 26, 2012

(54) DEVICE FOR TRANSPORTING SKIS

(76) Inventors: Johannes Bouwe Van Der Wal, Aldeboarn (NL); Gert Jan Brons, Peize (NL)

(21) Appl. No.: 13/382,958

(22) PCT Filed: Jun. 29, 2010
(86) PCT No.: PCT/NL10/50407

§ 371 Date: Apr. 10, 2012

(30) Foreign Application Priority Data
Jun. 29, 2009 (NL) 1037084

(51) Int. Cl. A63C 11/02; B62B 1/26

(52) U.S. Cl. 280/47.131

(57) ABSTRACT

The invention relates to a device (1) for transporting skis, comprising at least one wheel (5) which is rotatable about a rotation axle (4) and a first support surface (6) for supporting the skis, in which the distance (7) between a point (8) situated in the first support surface and the rotation axle is at least 40 cm. As a result thereof, it is possible to provide a simple device in which a user has to perform only minimal lifting.

### BACKGROUND OF THE INVENTION

The invention relates to a device for transporting skis. It comprises at least one wheel which is rotatable about a rotation axle and a first support surface for supporting the skis.

In order to reach the skiing piste, skiers often have to walk considerable distances in their ski boots with the skis and ski poles on their shoulders, for example from their accommodation to the skiing piste. Since ski boots are not optimum for walking and the skis and ski poles are heavy and unwieldy, this walk is often cumbersome and tiring. Another problem is the fact that the skis cannot readily be set down anywhere. The skis can be placed against a wall or can be laid on the ground, but in either case they are still inconvenient obstacles.

Large devices are known for transporting skis and, if desired, ski poles and ski boots. Such devices can be used to house and transport the skis. The weight of such a device is such that it forms a stable unit which can be set down in a virtually vertical position, also if it contains the skis, ski poles and ski boots. However, due to their size, these devices are difficult to transport in a car or in a ski lift and they are an inconvenient obstacle when not in use. In addition, they have a distinctive shape and it is thus difficult to find somewhere where they are out of sight and can be left safely. In addition, such devices are heavy, making pulling or pushing more cumbersome. Another drawback is the relatively high cost for manufacturing such a device, due to the relatively heavy frame, the durable transport means required, for example wheels, and the handle which such a device is often equipped with.

More convenient devices for transporting skis, such as described in NL 1026982, NL 1023700, NL 1015688 and DE 8910565 only hold one end of the skis, as a result of which the user can take the other end of the skis and can pull the skis. A significant drawback of these convenient devices is that the skis cannot be set down anywhere. Another drawback is the fact that, due to their tight-fitting engagement means, they can often not be adjusted for skis of different sizes or only with great difficulty. Furthermore, the skis are arranged in these devices with their wide side parallel to the pivot axle, for example the wheel axle, as a result of which the other ends of the skis have to be held in such a manner that the wide side is directed downwards. This is unpleasant since this side of the skis does not fit the palm of the hands very well. Furthermore, any imprints on the wide side of the skis are not clearly visible to others during transportation. Another drawback is the fact that the wheels are usually too small to be able to walk through loose snow easily.

A drawback of most known devices for transporting skis is the fact that the part which is used to rest on the fixed surroundings is situated near the ends of the skis and the part which is held by the user is situated near the other ends of the skis. In this case, the centre of gravity of the unit is approximately in the centre and the user has to carry a large portion of the total weight himself. An embodiment of this type is also shown, for example, in US 2004/0155417. The ski caddy shown in this publication has a telescopic handle which is provided at one end with wheels and a support part for one end of the skis and a handle and a further support part at the other end of the telescopic handle. In this case as well, the user has to carry a significant portion of the weight of the skis and setting down the skis in a stable manner also requires a few operations.

U.S. Pat. No. 3,779,568 describes a ski carrier provided with a baseplate provided with two wheels placed one behind the other and a clamping part near the baseplate for holding one end of the skis in a clamping manner. This device does not seem to be very stable, as a result of which the user has to carry a large part of the weight of the skis.

Finally, U.S. Pat. No. 6,070,906 describes a device for transporting a pair of, preferably several pairs of skis. This results in a transportation surface on which a bag containing items such as ski boots can rest in the vicinity of the wheels. At the wheels, the skis are clamped at one end. In this embodiment as well, the wheels are situated at the end of the skis. The various other pairs of skis are held together by means of a separate clamping part at a distance from the wheels. Thus, it seems complicated to transport a single pair of skis, particularly if further luggage, such as ski boots, has to be carried along.

In practice, most people appear to carry their skis themselves. The known devices thus do not seem to be able to satisfy the existing demand. There is therefore still a need for an improved device for transporting skis.

### SUMMARY OF THE INVENTION

It is an object of the present invention to provide an improved device for transporting skis.

In particular, it is an object of the invention to provide a device for transporting skis using as little expenditure of effort as possible, and preferably also for transporting luggage, such as ski poles, ski boots and the like.

It is a further and/or additional object of the invention to provide a device for safely setting down the skis, and preferably also the luggage.

It is a further and/or additional object of the invention to provide a device which is small and lightweight and easy to transport.

To this end, the invention provides a device for transporting skis, comprising at least one wheel which is rotatable about a rotation axle and a first support surface for supporting the skis, in which the distance between a point situated in the first support surface and the rotation axle plus the radius of the wheel is at least 40 cm, preferably 45-55 cm.

The advantage of such a device is that, due to the height of the first support surface, it becomes possible to support that part of the skis which is in or near the centre of the length of the skis, and thus usually in the vicinity of the centre of gravity of the skis, so that the largest part of the weight of the skis can be supported by the first support surface during transportation and thus does not have to be lifted by the user. The ends of the skis can be grasped by the user in order to transport the skis. The device is particularly suitable for a walker who holds one of the ends of the skis in his hands and pulls the skis along over the snow-covered ground. The abovementioned distance range is chosen such that when the skis are supported between the boot-attaching means, their weight mainly rests on the wheel during transportation by a user, such as a walker, and is linked to the height of the hands of the user. With most people, irrespective of whether they are tall or small, this height is approximately the same.

The expression “the distance between the first support surface” is understood to mean the mathematical distance between the support surface in a mathematical sense, since it is important that the skis are transported at a certain distance above the ground.

In one embodiment, the first angle between a line which is situated in the first support surface and is at right angles to the rotation axle and a line through the rotation axle and the centre of the first support surface is at least approximately 45°. In a particular embodiment, the first angle is approximately 50-60°. An important advantage of such a device is the fact that, when the skis are clamped against the first support surface, one of the ends of the skis, preferably the ends which are not held by the user for transportation, can rest on the ground in such a manner that they can form an upright unit together with the device. The skis can be set down by raising the ends which the user grasps in such a manner that the other ends can rest on the ground. Therefore, the skis can be set down in an oblique position by means of such a device, with the device and the skis balancing each other. In this case, the device according to the invention can support the skis in a safe and stable manner without the device having to be heavy. In a particular embodiment, the abovementioned angle is approximately 55 degrees. At a more acute angle, the skis are in a more upright position when they are set down. At a larger angle, the device can be in a more upright position during transportation of the skis so that a larger proportion of the weight of the skis rests on the device. The angle is also important for the stability of the unit, that is to say the device plus the skis, when the skis are being transported. In addition, the device according to the invention offers the possibility to support the skis at their centre of gravity, so that the user has to carry as little weight as possible during transportation.

In one embodiment, the first support surface forms part of a support part, which support part is releasably connected to the remaining part of the device. In this case, the support part is, in one embodiment, provided with the bearing surface described below and the clamping means described below. The support part can, for example, be connected to the remaining part of the device by means of a click-fit system. This may be simpler than attaching the skis to the support part. The skis may, for example, be placed in ski racks in the clamped state. The device can be supplied together with the skis when they are rented.

In certain situations, it may be advantageous if the first support surface forms part of a support part, which support part is hingedly connected to the remaining part of the device. For example, in order to be able to adjust the angle which the skis make with the remainder of the device, for example in order to set the skis down or in order to store the skis in a certain position. However, in order to carry out the function of setting down and transporting the skis, it is advantageous in most cases if the support part can hinge to a certain degree, and if, in one embodiment, it is immovably connected to the remainder of the device in order to carry out said functions.

In one embodiment, it may be desirable for the first support surface to form part of the support part and for this support part to be able to slide telescopically with respect to the remaining part of the device. In this way, it is possible to set the abovementioned distance, for example for children.

In one embodiment, the device according to the invention comprises a bearing surface and clamping means, with the bearing surface forming a second angle to the first support surface and with the clamping means being able to clamp the skis in this second angle. The clamping means may comprise metal or plastic clamps or may comprise hook and loop fasteners. In one embodiment, the first support surface and the bearing surface delimit a space which is sufficiently large for both wide/thick skis and narrow/thin skis to be accommodated therein and to be fixed by means of the clamping means. An advantage of such a device is the fact that the skis can be supported by the first support surface with the narrow side facing downwards, so that the user can grasp the narrow side of the skis and the imprint on the skis is visible to others. In one embodiment, that part of the skis which is in the vicinity of the boot-attaching means is supported by the first support surface, so that these protruding boot-attaching means can position the skis with respect to the first support surface. The clamping means may, if desired, also engage with these boot-attaching means.

In one embodiment, the device according to the invention comprises a suspension facility in the vicinity of the first support surface. The suspension facility, for example a simple hook or a part which can interact with a bag, for example a part of a press-stud closure, is situated at least 40 cm, in one embodiment 45-55 cm, above the ground during transportation, so that a bag can be suspended from this suspension facility which is, for example, 30 cm high. During transportation, the weight of the bag will rest mainly on the device. This bag can be used to store the ski boots. The walker can use his walking shoes for his walks. The bag can also be used to store the device in after use. When the skis are set down, the bag can be situated between the skis and the device and thus give the unit even more stability.

In one embodiment, the device according to the invention comprises at least two apertures in the vicinity of the pivot axle or in the vicinity of the rotation axle which can be used for accommodating the tip of a ski pole. The frame part extending from the pivoting point (mentioned below) to the wheel can comprise these apertures, for example. In this case, the weight of the poles rests on the pivot or rotation axle and the user only notices this weight due to the fact that the device has become heavier. Here, the ski poles are not transported parallel to the skis, as is the case in the most well-known devices. The ski poles will be at an angle to the skis during transportation and thus be clearly visible, as a result of which they will probably be forgotten less often.

In one preferred embodiment of the device according to the invention, the wheel is pivotable about a pivoting point and the device comprises a frame, which frame comprises a space, in which space the pivoting point is at least partially accommodated in a first position, in which first position the wheel is in a functional position for transporting skis. The pivoting point permits the wheel to be folded away. By accommodating the pivoting point in the space, this pivoting point is subject to less wear. The space may be present in a cavity of a tubular part of the frame.

In one embodiment, the pivoting point is connected to the frame by means of a spring-mounted element, which spring-mounted element is situated in the space and can be extended in such a manner that at least a large part of the pivoting point can leave the space in order to fold the wheel away. Due to the fact that a large part of the pivoting point can be pulled out of the space, the frame part from the pivoting point to the wheel can be manoeuvred in such a manner that the wheel can be folded away. In one embodiment, the wheels are also hinged with respect to this frame part so that the wheels can be provided parallel to this frame part. Thus, the device can be made as small as possible for the purpose of transporting the device itself.

In one embodiment, the device comprises a frame part, which frame part extends from the pivoting point to the wheel and comprises a support surface for resting the device on the ground in a second position, in which second position the wheel is folded away. This offers the advantage that the device can be set down in the second position, in which second position the device itself is transported. The frame part acts as a kind of stand for setting down the device.

In one embodiment of the device according to the invention, the latter comprises two second support surfaces for supporting the skis, which second support surfaces are in line with one another, and the first support surface is an imaginary surface which is situated between the two second support surfaces, with the first support surface and the two second support surfaces being substantially in line with one another. Such a device can comprise a support part, just like the embodiments which only comprise the first support surface, which support part here can be in the form of a forked or U-shaped construction, in which the two legs extend up to the second support surfaces. Unlike the embodiments which only have the first support surface which can support the skis between the boot-attaching means, the second support surfaces can support the skis beyond the boot-attaching means. In one embodiment, the support surface comprises at least two support parts which are substantially in line with and at a distance from one another.

The invention furthermore relates to a device for transporting skis, comprising a sliding surface which partially extends around a pivot axle so that the device can slide across the ground, and a first support surface for supporting the skis, in which the distance between a point situated in the first support surface and the sliding surface is at least 40 cm, in one embodiment 45-55 cm.

Such a device has the same advantages as described for the device having at least one wheel. However, for some surfaces, it may be advantageous to have a sliding surface instead of one or more wheels. The pivot axle is understood to be the axle about which the device can be pivoted when it is positioned on the ground. In one embodiment of the abovementioned device with a sliding surface, the second angle between a line which is situated in the first support surface and is at right angles to the pivot axle and a plumb line from that point to the pivot axle is at least 45°, in one embodiment 50-60°.

The invention furthermore relates to a device for transporting skis, comprising a frame having, at one end, at least one wheel which is rotatable about a rotation axle, and, at an opposite end, a support part for providing a first support surface for supporting the skis arranged with the longitudinal axis transversely to the rotation axle. In this case, the distance between the first support surface and the rotation axle is at least 40 cm, preferably 45-55 cm.

The invention furthermore relates to an assembly comprising at least one pair of skis having a longitudinal axis and a device for transporting the skis, the device comprising:
at least one wheel which is rotatable about a rotation axle;
a support part for providing a support surface for the skis arranged with the longitudinal axis substantially transversely to the rotation axle, and
a frame for keeping the rotation axle and the support surface at a distance apart, with the distance being at least 40 cm.

In case the frame is a tube which connects the rotation axle and the support part to one another, the length of said tube is at least 40 cm. In one embodiment, said length is then approximately 45-55 cm.

In one embodiment of the assembly, the transportation device comprises at least one set of wheels which are arranged on the rotation axle at a distance apart.

In one embodiment of the assembly, the support part keeps the skis with the longitudinal axis between the wheels.

In one embodiment of the assembly, the frame has a frame axis which intersects the rotation axle and which is at an angle of at least 45 degrees, 90-45 degrees, in one embodiment 50-60 degrees, to the longitudinal axis of the skis. In this case, with a frame which substantially consists of a tube, the frame axis is the axis of the tube. The tube is then connected at said angle.

In one embodiment, the frame connects the support part and the rotation axle in such a manner that a line through the rotation axle and the centre of gravity of the skis forms an angle of between 90 and 45 degrees to the longitudinal axis of the skis. As a result thereof, the skis can readily be set down and the unit is positioned in a stable manner.

In one embodiment of the assembly, the support part provides at least two supports which are spaced apart along the longitudinal axis of the skis. In one embodiment, the support part is a support plate which supports the skis across virtually its entire surface. In one embodiment, the support is situated at the position of the bindings, thus supporting the skis at their centre of gravity. Furthermore, the frame axis intersects the longitudinal axis of the skis between the supports, in one embodiment the frame axis intersects the longitudinal axis at the bindings of the skis.

In one embodiment of the assembly, the frame comprises a tube, in one embodiment a tube comprising telescopic tube sections, in one embodiment provided at one end with a support part for providing a support surface at an angle of 90-45 degrees to the longitudinal axis of the tube, and at another end a set of wheels on a rotation axle transverse to the longitudinal axis of the tube and transverse to the longitudinal axis of the skis.

In one embodiment of the assembly, the transportation device is furthermore provided with support parts for ski poles at the rotation axle for keeping the ski poles substantially along the longitudinal axis of the frame, at an angle with respect to the longitudinal axis of the skis.

It will be clear that the features of the assembly also form part of the above-described device and can be combined therewith.

The invention furthermore relates to a device provided with one or more of the characterizing features described in the attached description and/or illustrated in the attached drawings.

It will be clear that the various aspects mentioned in the present patent application can be combined and may each be considered individually for a divisional patent application.

### SHORT DESCRIPTION OF THE FIGURES

The invention will now be described in more detail with reference to non-limiting preferred embodiments of a device according to the invention, in which:

FIG. 1 shows a diagrammatic view of aspects of the preferred embodiment;

FIG. 2 shows a side view of the preferred embodiment;

FIG. 3 shows a side view of the preferred embodiment being used by a walker;

FIG. 4 shows a side view of the preferred embodiment in which the skis have been set down using the preferred embodiment;

FIG. 5 shows a cross section of the preferred embodiment, and

FIGS. 6A and 6B show a front and side view of a second position of the preferred embodiment, in which second position the wheels are folded away;

FIG. 7 shows a side view of a preferred embodiment having second support surfaces.

### DESCRIPTION OF PREFERRED EMBODIMENTS

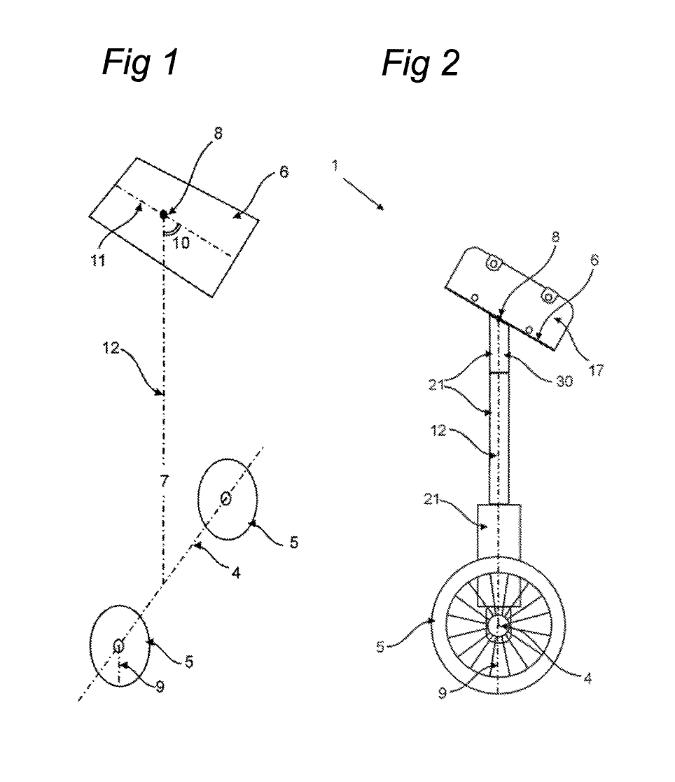

FIG. 1 diagrammatically shows a number of important aspects of the preferred embodiment. It shows two wheels (5) which are rotatable about a rotation axle (4), and a first support surface (6) for supporting the skis. The frame (21) is not illustrated in this figure. The distance (7) between a point (8) situated in the first support surface (6) and a rotation axle (4) plus the radius (9) is illustrated. One aspect of the invention is that this distance (7) is at least 40 cm, in one embodiment 45-55 cm. FIG. 1 also diagrammatically illustrates the first angle (10) between a line (11) which is situated in the first support surface (6) and is at right angles to the rotation axle (4) and a plumb line (12) from the point (8) to the rotation axle (4). Another aspect of the invention is that this first angle (10) is at least 45°, in one embodiment 50-60°. The first angle (10) in this figure is approximately 55°.

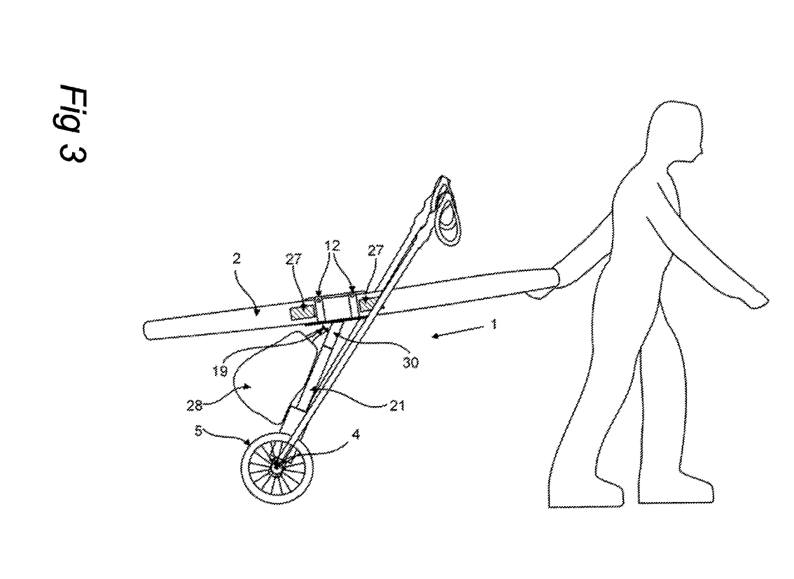

FIG. 2 shows the frame (21) of the embodiment, which frame (21) positions the first support surface (6) at a certain distance from the rotation axle and to which frame the wheels are attached. It can be seen that a plumb line (12) from a point (8) which is situated approximately in the centre of the first support surface (6) to the rotation axle (4) coincides with the axis of this frame. The first support surface forms part of a detachable support part (30), which support part (30) in turn forms part of the frame (21).

FIG. 3 shows how a walker grasps the ends of the skis with his hands and pulls the skis along, which are clamped by means of the clamping means (12) in the second angle (18, see FIG. 6A) between the boot-attaching means or bindings (27). In this case, the support part is a support plate on which the skis rest near the bindings (27) and which thus forms a support surface, and a stop (17) extends therefrom. The skis rest on the support plate (6) and bear against stop face (17), provided here by a stop plate (17) arranged transversely to the support plate (6). The bag (28) which hangs on the suspension facility (19) partially rests on the frame (21). The weight of the bag is situated substantially above the wheel (5), as a result of which the walker has to lift less weight. This results from the angle between the frame and the longitudinal axis of the skis.

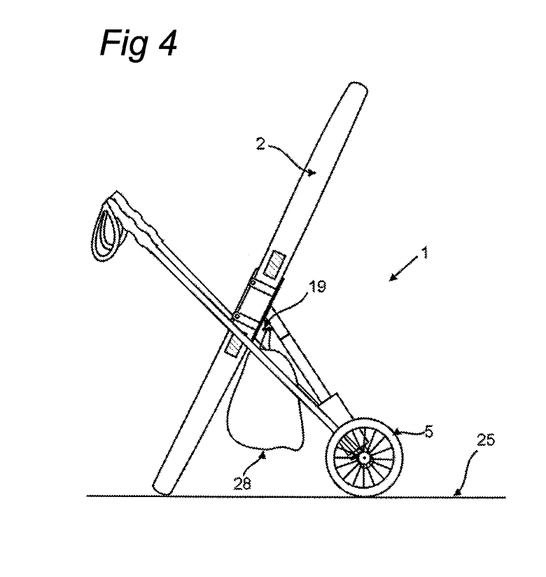

FIG. 4 shows how the device (1) according to the invention can be used for setting down skis. The device (1) and the skis (2) clamped thereto together form a stable unit which is balanced. In this figure, the suspension means (19) can be seen which is situated in the vicinity of the first support surface (6), from which suspension facility (19) a bag (28) is suspended.

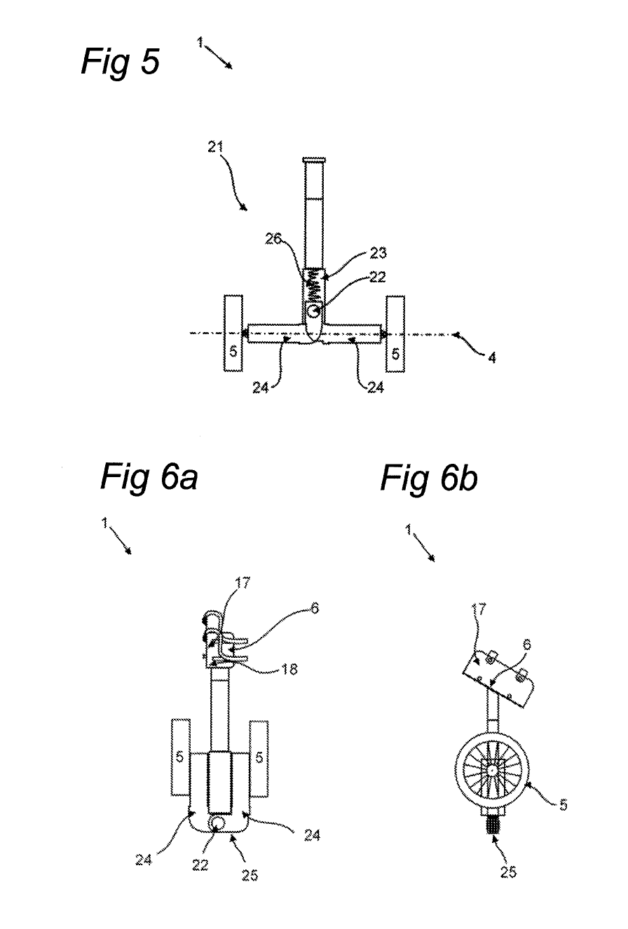

The frame (21) in FIG. 5 is in a first position, in which first position the wheels (5) are in a functional position for transporting the skis (2). The frame (21) is T-shaped. The wheels (5) can be folded away, as can be seen in FIGS. 6A and 6B. To this end, the wheels (5) are connected to one another by means of a pivoting point (22). In this position, the pivoting point (22) is accommodated in a space (23) of the frame (21). The pivoting point (22) is connected to the frame (21) by means of a spring-mounted element (26). The spring-mounted element (26) is situated in the space (23) and can be extended in such a manner that the pivoting point (22) can leave the space (23) in order to fold away the wheel (5). A frame part (24) extends from the pivoting point (22) to the wheel (5).

FIGS. 6A and 6B show the second position of the device, in which second position the wheels (5) are folded away. The frame part (24) comprises a support surface (25) for supporting the device (1) in a second position on the ground (15), in which second position the wheel (5) is folded away. As can be seen, the wheels (5) are hinged with respect to the frame part (24) so that the wheels can be positioned parallel to this frame part (24) in order to make the device (1) even more compact.

As an alternative, the wheels are detachable from the rotation axle. In this case, in one embodiment, the wheels may be provided with a sprung clamping part which rotatably locks the wheels on the rotation axle. In practice, the mutual distance between the wheels will be approximately 30-80 cm. In order to ensure good stability while retaining the compact design of the device, a distance of approximately 40-60 cm is a satisfactory solution.

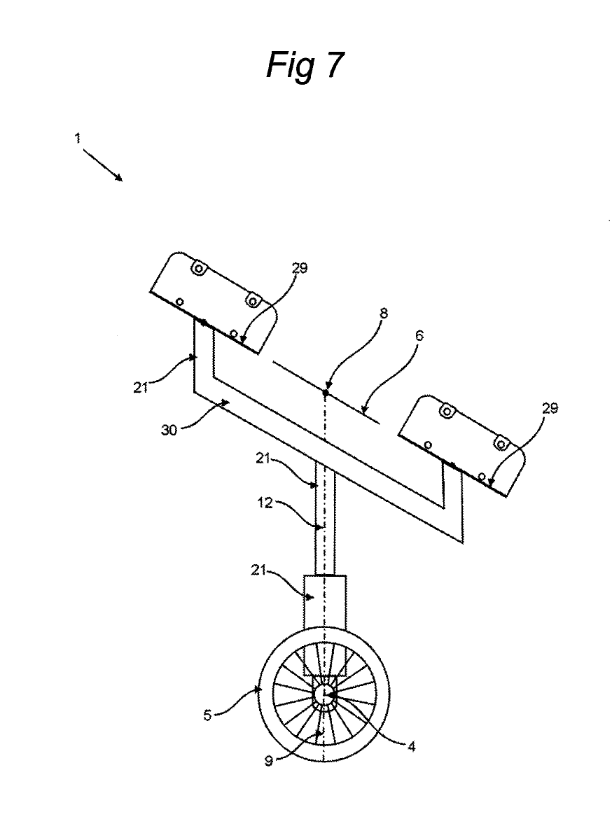

FIG. 7 shows the device according to the invention which comprises two second support surfaces (29). The second support surfaces are in line with one another and the first support surface (6) is an imaginary surface which is situated between the two second support surfaces, with the first support surface (6) and the two second support surfaces (29) being substantially in line with one another. In this preferred embodiment, the support part is U-shaped but can also be forked.

In particular, it was found that the device worked well if it was provided with wheels having a diameter of approximately 10-40 cm. In practice, a diameter of the wheels of approximately 20-30 cm was found to work well.

As is indicated in the figures, in practice, the first support surface is situated at the bindings of the skis. In practice, the support surface extends approximately 15-25 cm. In practice, the device is provided with a support surface of approximately 18-22 cm. In order to achieve a similar effect, it is of course also possible to provide at least two supports which are a distance apart, for example a distance which corresponds to the length of the support surface (6) given above. The skis can for example be clamped onto the support by means of tensioning belts which are known per se, or hook and loop fasteners and the like. This is known per se to those skilled in the field.

The angle between the frame when it is designed as a single tube, as illustrated in the figures, and the longitudinal axis of the skis, defined via the support surface (6), will in practice be approximately 50-70 degrees. Usually, values of approximately 55-65 degrees are chosen, in particular in view of the usual ski lengths of approximately 1.40-1.90 m. The distance between the supporting line and the rotation axle of the wheels will be approximately 35-45 cm. As a result thereof, the side of the skis which rest on the support surface will, at the centre of the bindings and when using the device, be located approximately 60-75 cm above ground.

It will be clear that in an alternative embodiment of the device (1) for transporting skis (2), the device (1) comprises a sliding surface (not shown) which partially runs around a pivot axle (13) so that the device (1) can slide across the ground (15), and a first support surface (6) for supporting the skis (2). In this case, the distance (7) between a point (8) situated in the first support surface (8) and the sliding surface can be at least 45 cm, in one embodiment 45-55 cm. In this embodiment, the wheels have effectively been replaced by sliding means, for example short skis.

In one embodiment of said device, a first angle (10) between a line (11) which is situated in the first support surface (6) and is at right angles to the pivot axle (13) and a plumb line (12) from the point (8) to the pivot axle (13) is at least 45°, in one embodiment 50-60°.

It will be clear that the above description has been given in order to illustrate the functioning of preferred embodiments of the invention, and not in order to limit the scope of the invention. On the basis of the above explanation, many variations which fall within the spirit and the scope of the present invention will be obvious to a person skilled in the art.

1. Device for transporting skis, comprising at least one wheel which is rotatable about a rotation axle and a first support surface for supporting the skis, characterized in that the distance between the first support surface and the rotation axle plus the radius of the wheel is at least 40 cm, preferably 45-55 cm.

2. Device according to claim 1, characterized in that a first angle between a line which is situated in the first support surface and is at right angles to the rotation axle, and a line through the rotation axle and the centre of the first support surface is at least 45°, preferably 50-60°.

3. Device according to one of claim 1 or 2, characterized in that the first support surface forms part of a support part, which furthermore comprises a bearing surface, which bearing surface forms a second angle to the first support surface, and the device comprises clamping means for clamping the skis against this bearing surface and onto the support surface.

4. Device according to one of the preceding claims, characterized in that it comprises a suspension facility in the vicinity of the first support surface.

5. Device according to one of the preceding claims, characterized in that it comprises at least two apertures, each for accommodating a tip of a ski pole, which two apertures are situated in the vicinity of the rotation axle.

6. Device according to one of the preceding claims, characterized in that the wheel is pivotable about a pivoting point, and the device comprises a frame, which frame comprises a space, in which space the pivoting point is at least partially accommodated in a first position, in which first position the wheel is in a functional position for transporting skis.

7. Device according to claim 6, characterized in that the pivoting point is connected to the frame by means of a spring-mounted element, which spring-mounted element is situated in the space and can be extended in such a manner that at least a large part of the pivoting point can leave the space in order to fold the wheel away.

8. Device according to claim 6, characterized in that a frame part extends from the pivoting point to the wheel and comprises a support surface for resting the device on the ground in a second position in which the wheel is folded away.

9. Device for transporting skis, comprising a frame having, at one end, at least one wheel which is rotatable about a rotation axle, and, at an opposite end, a support part for providing a first support surface for supporting the skis arranged with the longitudinal axis transversely to the rotation axle, characterized in that the distance between the first support surface and the rotation axle is at least 40 cm, preferably 45-55 cm.

10. Assembly comprising at least one pair of skis having a longitudinal axis and a device for transporting the skis, the device comprising:
at least one wheel which is rotatable about a rotation axle;
a support part for providing a support surface for the skis arranged with the longitudinal axis substantially transversely to the rotation axle, and
a frame for keeping the rotation axle and the support surface at a distance apart, with the distance being at least 40 cm.

11. Assembly according to the preceding claim, in which the transportation device comprises at least one set of wheels which are arranged on the rotation axle at a distance apart.

12. Assembly according to claim 10 or 11, in which the support part keeps the skis with the longitudinal axis between the wheels.

13. Assembly according to claims 10-12, in which the frame has a frame axis which intersects the rotation axle and which is at an angle of at least 45 degrees, 90-45 degrees, in one embodiment 50-60 degrees, to the longitudinal axis of the skis.

14. Assembly according to claims 10-13, in which the support part provides at least two supports which are spaced apart along the longitudinal axis of the skis, and the frame axis intersects the longitudinal axis of the skis between the supports, in one embodiment the frame axis intersects the longitudinal axis at the bindings of the skis.

15. Assembly according to one of claims 10-14, in which the frame comprises a tube, in one embodiment a tube comprising telescopic tube sections, in one embodiment provided at one end with a support part for providing a support surface at an angle of 90-45 degrees to the longitudinal axis of the tube, and at another end a set of wheels on a rotation axle transverse to the longitudinal axis of the tube and transverse to the longitudinal axis of the skis.

16. Assembly according to one of claims 10-15, furthermore provided with support parts for ski poles at the rotation axle for keeping the ski poles substantially along the longitudinal axis of the frame, at an angle with respect to the longitudinal axis of the skis.
